(19) United States
(12) Patent Application Publication
(10) Pub. No.: US 2008/0161453 A1
(43) Pub. Date: Jul. 3, 2008

(54) Polyphenylene Sulfide Resin Composition and Plastic Mold Produced Using the Same

(75) Inventors: Eun Joo LEE, Uiwang-si (KR); Chang Min HONG, Uiwang-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/958,459

(22) Filed: Dec. 18, 2007

(30) Foreign Application Priority Data
Dec. 29, 2006 (KR) 2006-0138229

(51) Int. Cl. C08K 5/47; C08K 5/36; C08K 3/30

(52) U.S. Cl. 524/83; 524/419

(57) ABSTRACT

A polyphenylene sulfide resin composition and a plastic mold produced using the same is disclosed. The composition includes a base resin including about 60 to about 95% by weight of a polyphenylene sulfide resin and about 5 to about 40% by weight of a polyphenylene ether resin, and about 0.01 to about 5.0 parts by weight of a disulfide compound based on 100 parts by weight of the base resin.

### CROSS-REFERENCE TO RELATED APPLICATION

This non-provisional application claims priority under 35 USC Section 119 from Korean Patent Application No. 10-2006-0138229, filed on Dec. 29, 2006, which is hereby incorporated by reference in its entirety.

### FIELD OF THE INVENTION

The present invention relates to a polyphenylene sulfide resin composition and a plastic mold produced using the same.

### BACKGROUND OF THE INVENTION

Recently, thermoplastic resins with high heat resistance and chemical resistance have been demanded as a material for the production of various electric/electronic equipment parts, vehicle equipment parts, or chemical equipment parts. Polyphenylene sulfide thermoplastic resins have been in the spotlight as possible thermoplastic resins capable of satisfying such requirements. Polyphenylene sulfide thermoplastic resins have several desirable properties such as heat resistance, dimensional stability, chemical resistance, flame resistance, and processability. Thus, research has focused on polyphenylene sulfide thermoplastic resins as a potential enhanced plastic material suitable for use as a substitute for metallic materials currently used in the production of precision parts of various optical parts or electric/electronic parts.

However, as compared to other resins, injection molding processes using polyphenylene sulfide thermoplastic resins can generate burrs. Burrs can be generated because the sheer rate dependency of a melt viscosity of the polyphenylene sulfide thermoplastic resin is small. Thus the polyphenylene sulfide resin composition can exhibit low melt viscosity in small gaps such as mold parting lines where the sheer rate is reduced during the molding process. As a result, the polyphenylene sulfide thermoplastic resin can easily flow through small spaces such as the mold parting line.

Various attempts to reduce burr generation during the molding process of polyphenylene sulfide thermoplastic resin have met with limited success. Even if burr generation is reduced to some extent during the molding process, other physical properties such as processability or mechanical strength of the polyphenylene sulfide thermoplastic resin can deteriorate.

### SUMMARY OF THE INVENTION

One aspect of the present invention is a polyphenylene sulfide resin composition capable of sufficiently reducing burr formation during molding processes, while inhibiting the deterioration of other physical properties of the polyphenylene sulfide thermoplastic resin.

The polyphenylene sulfide resin composition of the invention comprises a base resin comprising about 60 to about 95% by weight of a polyphenylene sulfide resin and about 5 to about 40% by weight of a polyphenylene ether resin; and about 0.01 to about 5 parts by weight of a disulfide compound based on 100 parts by weight of the base resin.

Another aspect of the present invention is a plastic mold produced using the polyphenylene sulfide resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In accordance with an embodiment of the present invention, a polyphenylene sulfide resin composition comprises a base resin including about 60 to about 95% by weight of a polyphenylene sulfide resin and about 5 to about 40% by weight of a polyphenylene ether resin; and about 0.01 to about 5 parts by weight of a disulfide compound based on 100 parts by weight of the base resin.

The polyphenylene sulfide resin composition includes the polyphenylene ether resin and the disulfide compound in addition to the polyphenylene sulfide resin as base constituent components. Including these two constituent components can reduce burr generation by the polyphenylene sulfide thermoplastic resin during molding processes, with substantially no deterioration of other physical properties of the resin, such as mechanical strength and processability.

The constituents of the polyphenylene sulfide resin composition will be described in detail with respect to each constituent component.

The polyphenylene sulfide resin composition includes a polyphenylene sulfide resin. The polyphenylene sulfide resin can include about 70 mole % or more of a repeating unit represented by the following formula 1. A polyphenylene sulfide resin including more than about 70 mole % of the repeating unit can exhibit high crystallinity, which is a characteristic of crystalline polymers, and superior heat resistance, chemical resistance and mechanical strength.

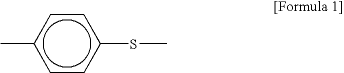

The polyphenylene sulfide resin may include at least one other repeating unit selected from the following formulas 2 to 9, in addition to the repeating unit of the formula 1. The polyphenylene sulfide resin can include the repeating units of formulas 2 to 9 in an amount of less than about 50 mole %, for example less than about 30 mole %.

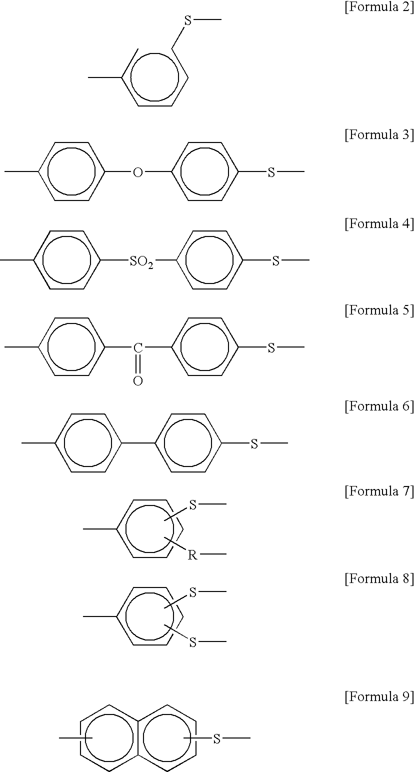

In the formula 7, R is a C1-C20 alkyl group, a nitro group, a phenyl group, a C1-C20 alkoxy group, a carboxyl group, or a metalcarboxylate group.

In general, it is known that the polyphenylene sulfide resin, depending on its preparation method, may have a linear molecular structure having no branched or crosslinked structure, or a molecular structure having a branched or crosslinked structure. However, as can be seen from the formulas 1 to 9, the polyphenylene sulfide resin included in the polyphenylene sulfide resin composition having any molecular structure can be effectively used.

A representative method for preparing a crosslinked polyphenylene sulfide resin is disclosed in Japanese Patent Publication No. Sho 45-3368. A representative method for preparing a linear polyphenylene sulfide resin is disclosed in Japanese Patent Publication No. Sho 52-12240.

To provide desired heat stability or workability of the polyphenylene sulfide resin composition, the polyphenylene sulfide resin can have a melt index (MI) value of about 10 to about 300 g/10 min at 316° C. under a load of 2.16 kg. When the melt index exceeds about 300 g/10 min, mechanical strength of a polyphenylene sulfide thermoplastic resin can decrease. On the other hand, when the melt index of the polyphenylene sulfide resin is less than about 10 g/10 min, the polyphenylene sulfide resin composition can exhibit low miscibility and workability during an injection process.

The polyphenylene sulfide resin forms a base resin together with a polyphenylene ether resin to be described later. The base resin can include the polyphenylene sulfide resin in an amount of about 60 to about 95% by weight, based on the total weight of the base resin.

The polyphenylene sulfide resin composition further includes a polyphenylene ether resin. Examples of polyphenylene ether resin suitable for use in the present invention can include poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, and a copolymer of poly(2,6-dimethyl-1,4-phenylene)ether and poly(2,3,5-triethyl-1,4-phenylene)ether, and the like, and mixtures thereof.

The degree of polymerization of the polyphenylene ether resin is not particularly limited. The inherent density of the polyphenylene ether resin can be about 0.2 to about 0.8 in a chloroform solvent of 25° C., to provide desired heat stability or workability of the polyphenylene ether resin composition.

The polyphenylene ether resin that can be used in the polyphenylene ether resin composition is not limited to the above-mentioned resins, and other polyphenylene ether resins can be used without any limitation.

The polyphenylene ether resin serves a role in reducing burr generation during the molding process of the polyphenylene sulfide thermoplastic resin.

The polyphenylene ether resin forms a base resin together with the polyphenylene sulfide resin. The base resin can include the polyphenylene ether resin in an amount of about 5 to about 40% by weight, based on the total weight of the base resin.

The polyphenylene sulfide resin composition also includes a disulfide compound. Examples of disulfide compounds suitable for use in the present invention can include benzothiazole disulfide, tetrabenzylthiuram disulfide, tetramethylthiuram disulfide, tetraethylthiuram disulfide, isopropylthiuram disulfide, phenylethylthiuram disulfide, and 2,2′-benzothiazolyl disulfide, and the like, and mixtures thereof.

The type of disulfide compound that can be used in the polyphenylene ether resin composition is not limited to the above-mentioned compounds, and other disulfide compounds can be used without any limitation.

The disulfide compound serves a role in preventing deterioration of the other physical properties, such as processability or mechanical strength of the polyphenylene sulfide thermoplastic resin, which can result from the addition of the polyphenylene ether resin.

The base resin can include the disulfide compound in an amount of about 0.01 to about 5 parts by weight, based on 100 parts by weight of the base resin including the polyphenylene sulfide resin and polyphenylene ether resin.

The polyphenylene sulfide resin composition can further include about 20 to about 250 parts by weight of a fibrous filler, an inorganic filler or a mixture thereof, based on 100 parts by weight of the base resin including the polyphenylene sulfide resin and polyphenylene ether resin, in addition to the above-mentioned components. Including the filler can further improve the mechanical strength or dimensional stability of the polyphenylene sulfide thermoplastic resin.

Examples of fibrous filler suitable for use in the present invention can include glass fiber, carbon fiber, aramid fiber, potassium titanate fiber, silicon carbide fiber, wollastonite, or the like, and mixtures thereof. Examples of the inorganic filler include powderous inorganic fillers such as calcium carbonate, silica, titanium oxide, carbon black, alumina, lithium carbonate, iron oxide, molybdenum disulfide, graphite, glass bead, talc, mica clay, zirconium oxide, calcium silicate, boron nitride, and the like, and mixtures thereof.

The type of filler that can be used is not limited to the above listed materials, and other fibrous fillers or inorganic fillers can be used.

The base resin can include the filler in an amount of about 20 to about 250 parts by weight, based on 100 parts by weight of the base resin including the polyphenylene sulfide resin and polyphenylene ether resin. The amount can vary, depending on the desired mechanical strength and dimensional stability of the polyphenylene sulfide thermoplastic resin.

The polyphenylene sulfide resin composition may further include, depending on its use, various additives such as an antioxidant, a release agent, a flame retardant, a lubricant, a colorant such as a pigment or a dye, or a small amount of multipolymer, and the like, and mixtures thereof, in addition to the above-mentioned components.

The above-mentioned components can be mixed together to prepare a polyphenylene sulfide resin composition. The polyphenylene sulfide resin composition can be subjected to a typical method for melt extrusion in an extruder to prepare a polyphenylene sulfide thermoplastic resin or a plastic molded product produced using the same.

In accordance with another embodiment of the present invention, there is provided a plastic molded product produced from the polyphenylene sulfide resin composition. The plastic molded product may be shaped to include a resin base material in which a polyphenylene sulfide resin, a polyphenylene ether resin, and a disulfide compound form a crosslinking bond.

The use of a resin base material in which the polyphenylene ether resin and disulfide compound together with the polyphenylene sulfide resin form a crosslinking bond can produce a molded product in a desired condition, because burr generation during the molding process is greatly reduced. At the same time, the other physical properties such as the mechanical strength or processability of the resin base material are not substantially deteriorated. Thus, the plastic molded product, such as a plastic mold, can be used as a substitute material for metallic materials for the production of precision parts of various optical parts or electric/electronic equipment parts.

Hereinafter, the constitution and operation of the present invention will be described in more detail with reference to the following Examples. These examples are provided only for illustrating the present invention and should not be construed as limiting the scope and spirit of the present invention.

Each constituent component of (A) a polyphenylene sulfide resin, (B) a polyphenylene ether resin, (c) a disulfide compound, and (d) a fibrous filler, an inorganic filler or a mixture thereof to be used in the following Examples and Comparative Examples will be described in detail.

(A) Polyphenylene Sulfide Resin

As a polyphenylene sulfide resin, PPS manufactured by DIC corp., Japan, exhibiting a melt index of 50 to 100 g/10 min at 316° C. under a load of 2.16 kg is used.

(B) Polyphenylene Ether Resin

As a polyphenylene ether resin, poly(2,6-dimethyl-phenylether) [product name: P-402] manufactured by Asahi Kasei Corp., Japan is used. Such a polyphenylene ether resin is in the form a powder having an average particle size of several tens of μm.

(C) Disulfide Compound

As a disulfide compound, 2,2′-benzothiazolyl disulfide manufactured by DC Chemical Co., Ltd. is used.

(D) Fibrous Filler, Inorganic Filler, or Mixture thereof

(D1) Fibrous Filler

A glass fiber manufactured by Owens Corning Korea treated with a coupling agent such as amino silane or methoxy silane, a lubricant, and a sizing agent, and having a diameter of 13 μm and a chop length of 3 mm is used.

(D2) Calcium Carbonate

As calcium carbonate, KRISTON-SS manufactured by Dongwha Materials Corp. having an average particle size of 1.7 μm is used.

### EXAMPLES 1 TO 4 AND COMPARATIVE EXAMPLES A TO D

The above-mentioned components are mixed together with the amounts set forth in Table 1, respectively. Then, an antioxidant and a heat stabilizer are added thereto, and the mixture is mixed in a mixer. The thus prepared respective polyphenylene sulfide resin composition is inserted into a twin screw extruder with L/D=36 and ¢=45 mm, and passed through the extruder to form pellets. Subsequently, thermoplastic resin samples for evaluating various physical properties and a degree of a burr generation are prepared with a 10 oz injection machine at an injection temperature of 320° C.

The thermoplastic resin samples are set for 48 hours at 23° C. and 50% relative humidity, and various physical properties are measured on the samples using the following methods.

First, notch izod impact strength (⅛″) of the thermoplastic resin sample is measured based on the US Measurement Standard ASTM D256 for measuring an izod impact strength of plastics using a fixed weight (Impact Resistance Evaluation).

Flexural strength and flexural modulus of the thermoplastic resin sample are measured based on the US Measurement Standard ASTM D790 for measuring various flexural characteristics of plastics (Mechanical Strength Evaluation).

The length of the burr generated during the molding process is measured with the above-mentioned injection conditions in a fixed mold (A degree of a Burr Generation Evaluation).

In addition, extrusion yield during the above-mentioned extrusion and injection process is measured (Processability and Extrusion Workability Evaluation).

Values of various physical properties and degrees of burr generation measured via these methods are presented in the following Table 1.

TABLE 1

| | | Example | | | | Comparative Example | | | |
|---|---|---|---|---|---|---|---|---|---|
| | | 1 | 2 | 3 | 4 | A | B | C | D |
| (A) Polyphenylene | | 80 | 80 | 90 | 70 | 100 | 70 | 80 | 100 |
| sulfide resin | | | | | | | | | |
| (B) Polyphenylene | | 20 | 20 | 10 | 30 | — | 30 | 20 | — |
| ether resin | | | | | | | | | |
| (C) Disulfide | | 0.5 | 2 | 1 | 1 | — | — | — | 2 |
| compound | | | | | | | | | |
| (D) Filler | (D1) | 100 | 100 | 100 | 100 | 100 | 100 | 100 | 100 |
| | (D2) | 85 | 85 | 85 | 85 | 85 | 85 | 85 | 85 |

| | | | | | | | | |
|---|---|---|---|---|---|---|---|---|
| Flexural Strength | 2000 | 1900 | 2200 | 1900 | 1500 | 1300 | 1500 | 1500 |
| (kg/cm²) | | | | | | | | |
| Extrusion Yield (%) | 95 | 95 | 95 | 95 | 90 | 60 | 70 | 90 |
| Izod Impact Strength | 7 | 6 | 8 | 6 | 6 | 5 | 6 | 6 |
| (kg · cm/cm) | | | | | | | | |
| Burr Length | 0.2 | 0.2 | 0.2 | 0.1 | 3 | 0.3 | 0.5 | 3 |
| (mm) | | | | | | | | |

Referring to Table 1, Examples 1 to 4 including a polyphenylene ether resin and a disulfide compound have greatly reduced burr length generated during the molding process as compared with the sample of Comparative Examples A to D. When the samples of Examples 1 and 2 and the sample of Comparative Example C are compared, Examples 1 and 2 including the disulfide compound in addition to the polyphenylene ether resin exhibit substantially no deterioration in the other physical properties such as the extrusion yield (extrusion workability) or mechanical strength.

Therefore, the Examples demonstrate the samples of Examples 1 to 4 exhibit no deterioration of the other properties despite the large reduction in burr length.

Moreover, the Examples demonstrate that the samples of Examples 1 to 4 also have other excellent physical properties.

According to the present invention, the polyphenylene sulfide resin composition is capable of greatly reducing burr generation during the molding process, while having substantially no deterioration of the other physical properties such as a mechanical strength or processability of the polyphenylene sulfide thermoplastic resin. Moreover, the polyphenylene sulfide thermoplastic resin of the invention can exhibit even more improved various physical properties.

Therefore, a plastic molded product exhibiting excellent physical properties using the resin composition can be produced. The plastic molded product can be used for the production of precision parts of various optical parts or electric/electronic equipment parts.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polyphenylene sulfide resin composition comprising:
a base resin comprising about 60 to about 95% by weight of a polyphenylene sulfide resin and about 5 to about 40% by weight of a polyphenylene ether resin; and
about 0.01 to about 5.0 parts by weight of a disulfide compound based on 100 parts by weight of the base resin.

2. The composition according to claim 1, wherein the polyphenylene sulfide resin comprises more than about 70 mole percent of a repeating unit of the following formula 1.

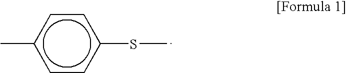

3. The composition according to claim 1, wherein the polyphenylene sulfide resin has a melt index (MI) of about 10 to about 300 g/10 min at 316° C. under a load of 2.16 kg.

4. The composition according to claim 1, wherein the polyphenylene ether resin comprises a resin selected from the group consisting of poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, and a copolymer of poly(2,6-dimethyl-1,4-phenylene)ether and poly(2,3,5-triethyl-1,4-phenylene)ether, and mixtures thereof.

5. The composition according to claim 1, wherein the polyphenylene ether resin has an inherent density of about 0.2 to about 0.8 in a chloroform solvent of 25° C.

6. The composition according to claim 1, wherein the disulfide compound comprises a compound selected from the group consisting of benzothiazole disulfide, tetrabenzylthiuram disulfide, tetramethylthiuram disulfide, tetraethylthiuram disulfide, isopropylthiuram disulfide, phenylethylthiuram disulfide, and 2,2′-benzothiazolyl disulfide, and mixtures thereof.

7. The composition according to claim 1, wherein the composition further comprises about 20 to about 250 parts by weight of a fibrous filler, an inorganic filler, or a mixture thereof based on 100 parts by weight of the base resin.

8. A plastic molded product produced using a polyphenylene sulfide resin composition comprising a base resin comprising about 60 to about 95% by weight of a polyphenylene sulfide resin and about 5 to about 40% by weight of a polyphenylene ether resin; and about 0.01 to about 5.0 parts by weight of a disulfide compound based on 100 parts by weight of the base resin.

9. A plastic molded product comprising a resin base material in which a polyphenylene sulfide resin, a polyphenylene ether resin, and a disulfide compound form a crosslinking bond.
